(19) United States
(12) Patent Application Publication
(10) Pub. No.: US 2025/0070339 A1
(43) Pub. Date: Feb. 27, 2025

(54) SECONDARY BATTERY

(71) Applicant: Samsung SDI Co., Ltd, Yongin-si, Gyeonggi-do (KR)

(72) Inventors: Seo Young KIM, Yongin-si (KR); Dae Kyung HAN, Yongin-si (KR)

(21) Appl. No.: 18/434,500

(22) Filed: Feb. 6, 2024

(30) Foreign Application Priority Data
Aug. 24, 2023 (KR) 10-2023-0111085

(51) Int. Cl. H01M 50/166; H01M 50/103; H01M 50/15

(52) U.S. Cl. CPC H01M 50/166; H01M 50/103; H01M 50/15

(57) ABSTRACT

A secondary battery includes: a case having a prismatic shape; an electrode assembly in the case; and a cap assembly including a cap plate coupled to one end of the case, wherein the case includes a coupling portion provided in a shape concave from an inner surface toward an outer side along an upper region of at least some surfaces thereof, and the coupling portion includes an inclined surface, a connection surface, and a stepped portion.

### CROSS-REFERENCE TO RELATED APPLICATION

The present application claims priority to and the benefit of Korean Patent Application No. 10-2023-0111085, filed on Aug. 24, 2023, the entire disclosure of which is incorporated herein by reference.

### BACKGROUND

### 1. Field

Aspects of some embodiments of the present disclosure relate to a secondary battery.

### 2. Description of the Related Art

Secondary batteries may include an electrode assembly in which a positive electrode plate and a negative electrode plate are stacked or rolled with a separator interposed therebetween, a case accommodating the electrode assembly together with an electrolyte, and a cap assembly sealing the case. The cap assembly may include a cap plate sealing the case, positive and negative electrode terminals electrically connected to the electrode assembly, and the like. The cap plate may be coupled to the case by a method such as, welding or press fitting.

The case may be made slightly larger in size than the cap plate for the press fitting coupling, and in this case, the cap plate may be prone to over-insertion. When the cap plate is over-inserted, the cap plate may be too close to the electrode assembly, which may cause problems such as an electrode assembly being dented.

In addition, when the cap plate is larger in size than the case, a coupling portion of the case coupled to the cap plate may be scratched by the cap plate, which may cause scratch burrs or damage to the case.

The above information disclosed in this Background section is only for enhancement of understanding of the background and therefore the information discussed in this Background section does not necessarily constitute prior art.

### SUMMARY

Aspects of some embodiments of the present disclosure relate to a secondary battery in which a coupling structure of a cap assembly is improved.

According to some embodiments of the present disclosure, there is provided a secondary battery including a case having a prismatic shape, an electrode assembly accommodated in the case, and a cap assembly including a cap plate coupled to one end of the case, wherein the case may include a coupling portion provided in a shape concave from an inner surface toward an outer side along an upper region of at least some surfaces thereof, and the coupling portion may include an inclined surface, a connection surface, and a stepped portion.

According to some embodiments, the inclined surface may be formed to be inclined downward from an upper end of the case.

According to some embodiments, the inclined surface may have an angle (e) in a range of 72.7° to 79.2° with respect to an upper surface of the case.

According to some embodiments, the connection surface may extend downward from the inclined surface and may be connected to the stepped portion.

According to some embodiments, the stepped portion may have an angle of 90° with respect to the connection surface.

According to some embodiments, a coating layer may be provided on a surface of the coupling portion.

According to some embodiments, the coating layer may be provided in a region covering the inclined surface, the connection surface, and the stepped portion.

According to some embodiments, the coating layer may be provided in a region wider than the inclined surface, the connection surface, and the stepped portion.

According to some embodiments, the cap plate may be coupled to the coupling portion by press fitting.

### BRIEF DESCRIPTION OF THE DRAWINGS

The above and other objects, features, and characteristics of embodiments according to the present disclosure will become more apparent to those of ordinary skill in the art by describing aspects of some embodiments thereof in more detail with reference to the accompanying drawings, in which:

FIG. 1 is a perspective view of a secondary battery according to some embodiments of the present disclosure;

FIG. 2 is a perspective view illustrating a cap assembly and an electrode assembly of the secondary battery of FIG. 1 according to some embodiments of the present disclosure;

FIG. 3 is a perspective view illustrating a portion of a case of the secondary battery of FIG. 1 according to some embodiments of the present disclosure; and

FIG. 4 is a cross-sectional view illustrating a coupling portion between a cap plate and the case of the secondary battery of FIG. 1 according to some embodiments of the present disclosure.

### DETAILED DESCRIPTION

Aspects of some embodiments of the present disclosure are provided to more fully describe the present disclosure to those of ordinary skill in the art, the following embodiments may be modified into various other forms, and the scope of the present disclosure is not limited to the following embodiments. Rather, these embodiments are provided so that the present disclosure will be more thorough and complete, and will more fully convey aspects of embodiments of the present disclosure to those of ordinary skill in the art.

In addition, in the following drawings, the thickness or size of each layer is exaggerated for convenience and clarity of description, and like reference numerals in the drawings refer to like elements. As used herein, the term “and/or” includes any and all combinations of one or more of the associated listed items. In addition, in the present specification, the meaning of “connected” means not only a case in which member A and member B are directly connected, but also a case in which member C is interposed between member A and member B so that member A and member B are indirectly connected.

The terms used herein are used to describe specific embodiments and are not intended to limit the present disclosure. As used in the present specification, a singular form may, unless the context clearly indicates otherwise, include a plural form. In addition, the expressions “comprise or include” and/or “comprising or including” used in the present specification specify the presence of mentioned shapes, numbers, steps, operations, members, elements, and/or groups thereof, but do not exclude the presence or addition of one or more other different shapes, numbers, steps, operations, members, elements, and/or groups thereof.

As used herein, terms such as “first,” “second,” and the like are used to describe various members, components, regions, layers, and/or portions. However, it is obvious that the members, components, regions, layers, and/or portions should not be defined by these terms. These terms are used only for distinguishing one member, component, region, layer, or portion from another member, component, region, layer, or portion. Thus, a first member, component, region, layer, or portion described below may also refer to a second member, component, region, layer, or portion, without departing from the spirit of the present disclosure.

Spatially relative terms, such as “beneath,” “below,” “lower,” “above,” “upper” and the like, may be used herein for ease of description to describe one element or feature's relationship to another element or feature as illustrated in the drawings. These spatially relative terms are intended for easy comprehension of the present disclosure according to various process states or usage states of the present disclosure, and thus, the present disclosure is not limited thereto. For example, if an element or feature shown in the drawings is turned over, the element or feature described as “beneath” or “below” may becomes “above” or “upper.” Accordingly, the term “below” is a concept encompassing “above” or “below.”

Hereinafter, a secondary battery according to some embodiments of the present disclosure will be described in more detail with reference to the accompanying drawings.

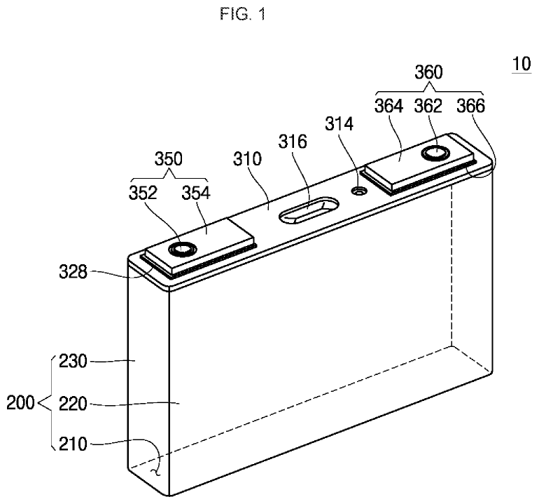

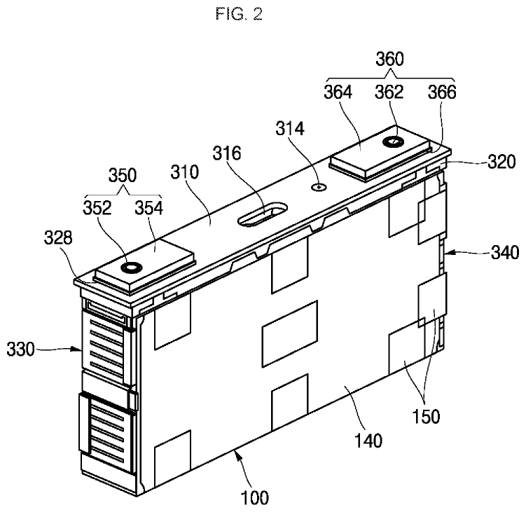

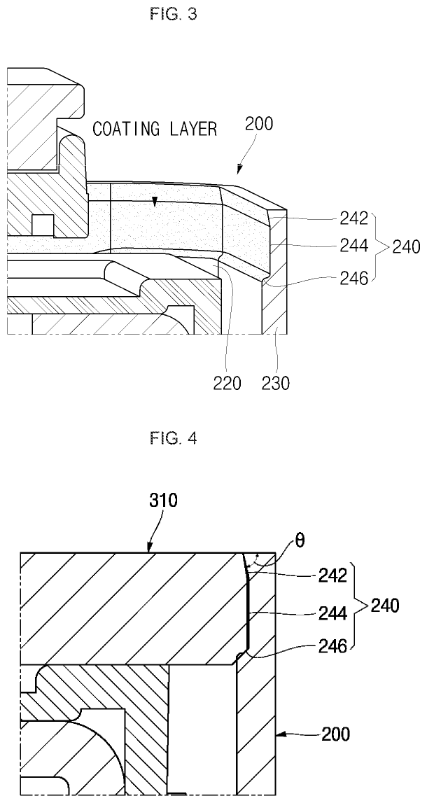

FIG. 1 is a perspective view of a secondary battery according to some embodiments of the present disclosure. FIG. 2 is a perspective view illustrating a cap assembly and an electrode assembly of the secondary battery of FIG. 1. FIG. 3 is a perspective view illustrating a portion of a case of the secondary battery of FIG. 1. FIG. 4 is a cross-sectional view illustrating a coupling portion between a cap plate and the case of the secondary battery of FIG. 1.

As shown in FIGS. 1 and 2, a secondary battery 10 according to some embodiments of the present disclosure may include an electrode assembly 100, a case 200 accommodating the electrode assembly 100, and a cap assembly 300 coupled to the case 200. As an example, the secondary battery 10 may be a prismatic battery of which the case 200 has a rectangular parallelepiped shape.

As shown in FIG. 2, the electrode assembly 100 may be provided by winding a unit stack including thin plate- or film-shaped first and second electrode plates and a separator interposed therebetween, or stacking a plurality of unit stacks. When the electrode assembly 100 is formed by winding, a winding axis may be arranged in a horizontal direction approximately parallel to a longitudinal direction of the cap assembly 300 or in a vertical direction approximately perpendicular to the longitudinal direction of the cap assembly 300. When the electrode assembly 100 is formed by stacking, long side surfaces of the plurality of unit stacks may be arranged adjacent to each other. A sheet 140 of an insulating material may be attached to an exterior of the electrode assembly 100 by an insulating tape 150 to insulate the electrode assembly 100 from the case 200. As an example, the first electrode plate may be a negative electrode and the second electrode plate may be a positive electrode. Alternatively, the configuration may be reversed.

When the first electrode plate is a negative electrode plate, the first electrode plate may be formed by applying a first electrode active material such as graphite or carbon on a first electrode current collector provided as a metal foil such as copper, a copper alloy, nickel, or a nickel alloy. A first non-coated portion, which is a region not coated with the first electrode active material, may be formed on the first electrode plate. The first non-coated portion serves as a tab electrically connected to a first current collector plate 330, which will be described later, and thus the first non-coated portion may be defined as a first base tab. The first current collector plate 330 may be electrically connected to the cap assembly 300.

When the second electrode plate is a positive electrode plate, the second electrode plate may be formed by applying a second electrode active material such as a transition metal oxide on a second electrode current collector provided as a metal foil such as aluminum or an aluminum alloy. A second non-coated portion, which is a region not coated with the second electrode active material, may be formed on the second electrode plate. The second non-coated portion serves as a tab electrically connected to a second current collector plate 340 to be described later, and thus the second non-coated portion may be defined as a second base tab. The second current collector plate 340 may be electrically connected to the cap assembly 300.

The separator is arranged between the first electrode plate and the second electrode plate to prevent or reduce instances of a short circuit and allow lithium ions to move. As an example, the separator may include polyethylene, polypropylene, or a composite film of polyethylene and polypropylene. However, the material of the separator is not limited to the above-described examples.

The electrode assembly 100 having the above-described structure may be accommodated in the case 200 together with an electrolyte. In some embodiments, the electrolyte may include a lithium salt such as LiPF₆, LiBF₄, or the like in an organic solvent such as ethylene carbonate (EC), propylene carbonate (PC), diethyl carbonate (DEC), ethyl methyl carbonate (EMC), dimethyl carbonate (DMC), or the like. In addition, the electrolyte may be a liquid or gel. In some embodiments, when an inorganic solid electrolyte is used, the electrolyte may be omitted.

As shown in FIG. 1, the case 200 may be formed in the form of a substantially rectangular parallelepiped box having an open upper portion in a longitudinal direction and an accommodation space formed therein. The electrode assembly 100 and the electrolyte may be accommodated in the case 200 through the open upper portion. Some components of the cap assembly 300 are exposed to the outside of the case 200, and some components may be accommodated in the case 200. The case 200 may include a rectangular bottom surface 210 and four side surfaces connected to the bottom surface 210. Among the side surfaces, a surface having a relatively large area is defined as a long side portion 220 and a surface having a relatively small area is defined as a short side portion 230. As an example, the electrode assembly 100 may be arranged such that a plate surface having a relatively large area faces the long side portion 220. In a state in which the electrode assembly 100 is accommodated in the case 200, the cap assembly 300 is coupled to the case 200 and is electrically connected to the electrode assembly 100. In more detail, a coupling portion 240 to which a cap plate 310 to be described later is coupled is provided in an upper region of the case 200.

The coupling portion 240 may be provided in a shape concave from an inner surface toward an outer side along the upper region of the case 200. The coupling portion 240 may include an inclined surface 242, a connection surface 244, and a stepped portion 246. In some embodiments, the coupling portion 240 may be provided only in an upper region of the short side portion 230. In addition, in some embodiments, the coupling portion 240 may be provided to be connected to both the long side portion 220 and the short side portion 230.

The inclined surface 242 is a surface formed to be inclined downward from an upper end of the case 200. The inclined surface 242 is provided to have a minimum angle to limit the movement of the cap plate 310 so that the cap plate 310 is not separated after being press-fitted into the case 200. As an example, when a vertical height (a vertical length between upper and lower ends of the inclined surface) of the inclined surface 242 is 0.5 mm, an angle θ between the inclined surface 242 and an upper surface of the case 200 may range from 72.7° to 79.2°. When the angle θ between the inclined surface 242 and the upper surface of the case 200 is less than 72.7°, it is difficult for the cap plate 310 to be inserted into the case 200. In addition, when the angle θ between the inclined surface 242 and the upper surface of the case 200 is greater than 79.2°, the cap plate 310 is separated from the case 200 and cannot maintained a coupled state with the case 200. Thus, the angle θ between the inclined surface 242 and the upper surface of the case 200 should be adjusted within the above-described range. In some embodiments, the angle θ between the inclined surface 242 and the upper surface of the case 200 may be 75°. The angle θ between the inclined surface 242 and the upper surface of the case 200 may be designed and changed in consideration of the vertical height of the inclined surface 242, the tolerance of a long side of the cap plate 310, the tolerance of an inner surface of the case 200, and the like. The connection surface 244 is integrally formed with a lower portion of the inclined surface 242.

The connection surface 244 is a surface approximately parallel to an outer surface of the case 200. The stepped portion 246 is integrally formed with a lower portion of the connection surface 244.

The stepped portion 246 is provided to be inclined downward from the connection surface 244. An angle of the stepped portion 246 formed with the connection surface 244 may be 90° or 90° or more. However, the angle of the stepped portion 246 may be adjusted within a range in which the cap plate 310 can be held without slipping. Further, the stepped portion 246 may have a streamlined surface rather than a straight line. The stepped portion 246 acts as a holding protrusion to prevent or reduce instances of the cap plate 310 being over-inserted and lowered toward the electrode assembly 100.

The coupling portion 240 having the structure described above may have a coating layer formed on a surface thereof. The coating layer may be formed by a method such as applying or spraying a resin material. The coating layer may be formed entirely on the coupling portion 240, or may be formed such that a coating material has a specific pattern. As an example, the coating material may be applied in a pattern such as a plurality of dots, a grid, or a comb. In addition, as an example, the coating layer may be provided in a wider region than the coupling portion 240 or may be provided only on the inclined surface 242 and the connection surface 244. A frictional force of the coupling portion 240 is increased due to the coating layer, and thus a fixing force of the cap plate 310 can be increased and separation may be effectively prevented or reduced even when the cap plate 310 is not welded after being inserted. In addition, instances of scratch burrs formed on the surface of the coupling portion 240, which may be generated due to scratches with the case 200 occurring when the cap plate 310 is press-fitted, may be prevented or reduced.

As shown in FIGS. 1 and 2, the cap assembly 300 may include the cap plate 310 coupled to the case 200, a plurality of insulating members, the first current collector plate 330, the second current collector plate 340, a first terminal portion 350, and a second terminal portion 360.

The cap plate 310 may be formed in the form of a substantially rectangular plate, and may be formed of the same material as the case 200. Terminal holes for coupling the first terminal portion 350 and the second terminal portion 360, respectively, a liquid injection hole 314, a vent hole for coupling a vent 316, and the like may be formed in the cap plate 310. A plurality of insulating members, such as an insulating plate 320, may be provided to insulate the cap plate 310 from the electrode assembly 100. As the cap plate 310 is press-fitted into the coupling portion 240 provided in the case 200, an edge of the cap plate 310 is deformed according to the shape of the coupling portion 240. Accordingly, the cap plate 310 can be firmly fixed to the coupling portion 240.

The first current collector plate 330 electrically connects a first electrode plate 110, which is a negative electrode plate, to the first terminal portion 350. To this end, the first current collector plate 330 may be made of the same material as the first electrode plate 110. As an example, the first current collector plate 330 may be electrically connected to the first base tab of the first electrode plate 110 by laser welding.

The second current collector plate 340 is arranged to be symmetrical to the first current collector plate 330 and is electrically connected to a second electrode plate 120. To this end, the second current collector plate 340 may be made of the same material as the second base tab of the second electrode plate 120. As an example, the second current collector plate 340 may be electrically connected to the second base tab of the second electrode plate 120 by laser welding.

The first terminal portion 350 may include a first terminal pin 352 and a first terminal plate 354. The first terminal plate 354 may be insulated from the cap plate 310 by an insulating member 328. The first terminal pin 352 is electrically connected to the first current collector plate 330 to be electrically connected to the first electrode plate 110 of the electrode assembly 100.

The second terminal portion 360 may include a second terminal pin 362, a second terminal plate 364, and a conductive plate 366. The second terminal portion 360 is arranged to be symmetrical to the first terminal portion 350. The conductive plate 366 electrically connects the cap plate 310 to the second terminal plate 364 electrically connected to the second terminal pin 362. Thus, because the cap plate 310 is connected to the second current collector plate 340 by the second terminal portion 360, the cap plate 310 can be electrically connected to the second electrode plate 120. Accordingly, the cap plate 310 has the same polarity as the second current collector plate 340.

As described above, by improving the coupling structure of the case and the cap plate, when the cap plate is press-fitted into the case without welding, over-insertion of the cap plate or stamping of the electrode assembly may be prevented or reduced.

In addition, scratch burrs occurring at a coupling portion of the case coupled to the cap plate due to the press fitting of the cap plate may be prevented or reduced.

According to some embodiments of the present disclosure, by improving a coupling structure of a cap plate, when the cap plate is coupled to a case by press fitting without welding, over-insertion or stamping of the electrode assembly may be prevented or reduced.

In addition, scratch burrs due to the press fitting of the cap plate occurring at a coupling portion of the case coupled to the cap plate may be prevented or reduced.

According to some embodiments of the present disclosure, by relatively improving a coupling structure of the cap plate, when the cap plate is coupled to the case by press fitting without welding, over-insertion or denting of the electrode assembly may be avoided. In addition, scratch burrs due to the press fitting of the cap plate occurring at a coupling portion of the case coupled to the cap plate may be prevented or reduced.

The above-described embodiments illustrate aspects of some embodiments of the present disclosure, and embodiments according to the present disclosure are not limited to the above-described embodiments. As claimed in the following claims, the extent of the technical spirit of the present disclosure will encompass various modifications that can be made by anyone with ordinary knowledge in the field to which the invention pertains without departing from the spirit and scope of embodiments according to the present disclosure.

What is claimed is:

1. A secondary battery comprising:
a case having a prismatic shape;
an electrode assembly in the case; and
a cap assembly including a cap plate coupled to one end of the case,
wherein the case includes a coupling portion provided in a shape concave from an inner surface toward an outer side along an upper region of at least some surfaces thereof, and
the coupling portion includes an inclined surface, a connection surface, and a stepped portion.

2. The secondary battery as claimed in claim 1, wherein the inclined surface is inclined downward from an upper end of the case.

3. The secondary battery as claimed in claim 2, wherein the inclined surface has an angle (θ) in a range of 72.7° to 79.2° with respect to an upper surface of the case.

4. The secondary battery as claimed in claim 3, wherein the connection surface extends downward from the inclined surface and is connected to the stepped portion.

5. The secondary battery as claimed in claim 4, wherein the stepped portion has an angle of 90° with respect to the connection surface.

6. The secondary battery as claimed in claim 1, wherein a coating layer is on a surface of the coupling portion.

7. The secondary battery as claimed in claim 6, wherein the coating layer is in a region covering the inclined surface, the connection surface, and the stepped portion.

8. The secondary battery as claimed in claim 7, wherein the coating layer is in a region wider than the inclined surface, the connection surface, and the stepped portion.

9. The secondary battery as claimed in claim 8, wherein the cap plate is coupled to the coupling portion by press fitting.
